(19) United States
(12) Patent Application Publication
(10) Pub. No.: US 2010/0119765 A1
(43) Pub. Date: May 13, 2010

(54) Cleaning Strips For Cash And Credit Card Machines

(75) Inventors: Walter Kabis, Onex (CH); Walter Krienbühl-Gisler, Unterägeri (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ECS AG, Wollerau (CH)

(21) Appl. No.: 12/594,402

(22) PCT Filed: Mar. 18, 2008
(86) PCT No.: PCT/CH2008/000116

§ 371 Date: Nov. 16, 2009

(30) Foreign Application Priority Data
Apr. 2, 2007 (CH) 523/07

(51) Int. Cl. B32B 33/00

(52) U.S. Cl. 428/90

(57) ABSTRACT

A cleaning strip for cash and credit card machines comprises a strip coated with flock fibers and made of a substrate, wherein two opposing strip edges define a machine direction and the width of the strip measured transversely to an insertion direction into a cash and credit card machine corresponds substantially to the length of a side edge of a banknote or credit card suitable for use in a cash and credit card machine to be cleaned. On at least one of the surfaces thereof, the strip has at least three transverse strips (14), mounted transversely to the machine direction at a distance from each other and provided with a coating made of flock fibers.

### TECHNICAL FIELD

The invention relates to a cleaning strip or cleaning card for cash and credit card machines, with a strip coated with flock fibers and consisting of a carrier material, two mutually opposite strip edges defining a machine direction, and the width, measured transversely to a push-in direction into a cash and credit card machine, of the strip corresponding essentially to the length of a side edge of a banknote or credit card suitable for use in a cash and credit card machine to be cleaned.

### PRIOR ART

Cleaning strips or cleaning cards for machine systems with a card reader and banknote tester having a draw-through reader, mechanical insertion reader or reader having motor-operated draw-in are known. A known strip material consists of a cellulose fleece impregnated, if appropriate, with a cleaning agent. A cleaning card with a full-area flock coating and with a flock coating in the manner of a brick wall pattern is also known.

US 2005/0266211 A1 discloses a cleaning card consisting of a nonwoven with elevations arising from the card plane on both sides of the card and serving as cleaning surfaces.

A cleaning card consisting of a flexible plastic material, such as, for example, polyethylene or polypropylene, is known from WO 2007/016512 A2. Arcuate portions arise as cleaning surfaces out of the card plane on both sides of the card.

With the known cleaning strips and cleaning cards, the card readers and banknote testers of cash and credit card machines cannot always be cleaned satisfactorily without extra effort, and therefore machine failures are increasingly to be expected.

### Presentation of the Invention

The object on which the invention is based is to provide a cleaning strip or a cleaning card of the type initially mentioned with an improved cleaning action. Moreover, the cleaning strip or the cleaning card is to be capable of being handled simply and reliably.

The object is achieved according to the invention in that the strip has on at least one of its surfaces at least three transverse strips arranged at a distance from one another transversely to the machine direction and provided with a coating consisting of flock fibers.

So that the appliances to be cleaned can be cleaned effectively with as little effort as possible, the transverse strips are preferably arranged on both surfaces or on the front and the rear side of the strip.

Preferably, the transverse strips have a width of 5 to 15 mm, preferably of 8 to 12 mm, and a mutual distance of 5 to 20 mm, preferably of 8 to 18 mm.

In a particularly preferred embodiment of the cleaning strip or cleaning card according to the invention, the transverse strips arranged on one side of the strip lie between the transverse strips arranged on the other side of the strip.

### BRIEF DESCRIPTION OF THE DRAWING

Further advantages, features and details of the invention may be gathered from the following description of preferred exemplary embodiments and with reference to the drawing in which, diagrammatically,

FIG. 1 shows a top view of the front side of a cleaning strip for cash machines;

FIG. 2 shows a top view of the rear side of the cleaning strip of FIG. 1;

FIG. 3 shows a longitudinal section through the cleaning strip of FIG. 1 along its line I-I;

FIG. 4 shows a top view of the front side of a cleaning card for credit card machines;

FIG. 5 shows a top view of the rear side of the cleaning card of FIG. 4;

FIG. 6 shows a longitudinal section through the cleaning card of FIG. 4 along its line II-II;

FIG. 7 shows a longitudinal section through part of a cleaning card for credit card machines during a cleaning operation in an enlarged illustration.

### DESCRIPTION OF EXEMPLARY EMBODIMENTS

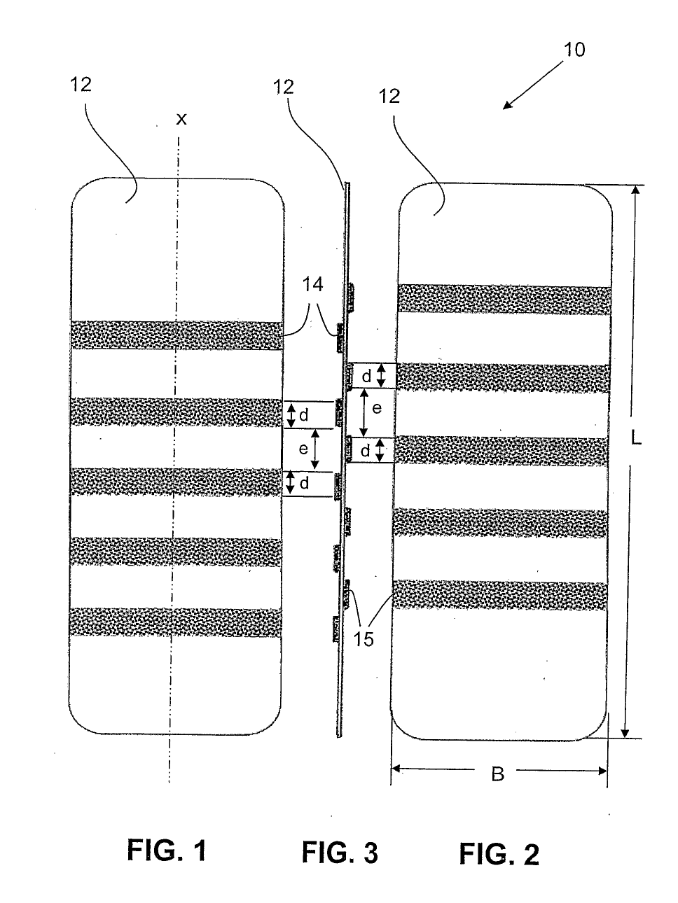

A cleaning strip 10 for cash machines, which is illustrated in FIGS. 1 to 3, has, for example, a length L of 185 mm and a width B of 65 mm. In the example shown, the longitudinal direction of the cleaning strip 10 corresponds to the push-in direction x of the banknote tester of a cash machine. The cleaning strip 10 comprises a strip 12 consisting of a flexible carrier material composed, for example, of polyvinyl chloride (PVC) with a thickness of 0.15 mm. The strip 12 is provided on both sides with transverse strips 14, 15 consisting of a flock coating composed, for example, of polyamide (PA) having the flock dimensions 1.00 mm/3.3 dtex, the first number referring to the length of the individual fibers and the second number to the density of the flock.

A flock coating or flocking is understood to mean the application of flock fibers to a surface. For this purpose, the surface regions to be flocked are covered, after pretreatment, with an adhesive. The initially randomly arranged flock fibers are oriented in an electrostatic field and are guided onto the surface by the latter. The adhesive is subsequently allowed to cure, and a uniform nap having fibers arising essentially vertically from the surface is obtained.

The transverse strips 14, 15 consisting of a flock coating have, for example, a width d of 9 mm and a distance between adjacent transverse strips of 15 mm. In the example shown, in each case five transverse strips 14 are arranged on the front side and in each case five transverse strips 15 are arranged on the rear side of the strip 12, the transverse strips 14 on the front side being arranged so as to be offset with respect to the transverse strips 15 on the rear side in the longitudinal direction of the strip 12 such that the transverse strips 14 on the front side lie in each case between the transverse strips 15 on the rear side, and vice versa. The height h of the transverse strips 14, 15 consisting of the flock coating corresponds approximately to the length of the individual flock fibers arising from the surface of the strip 12 consisting of carrier material, that is to say, in the present example, to about 1 mm.

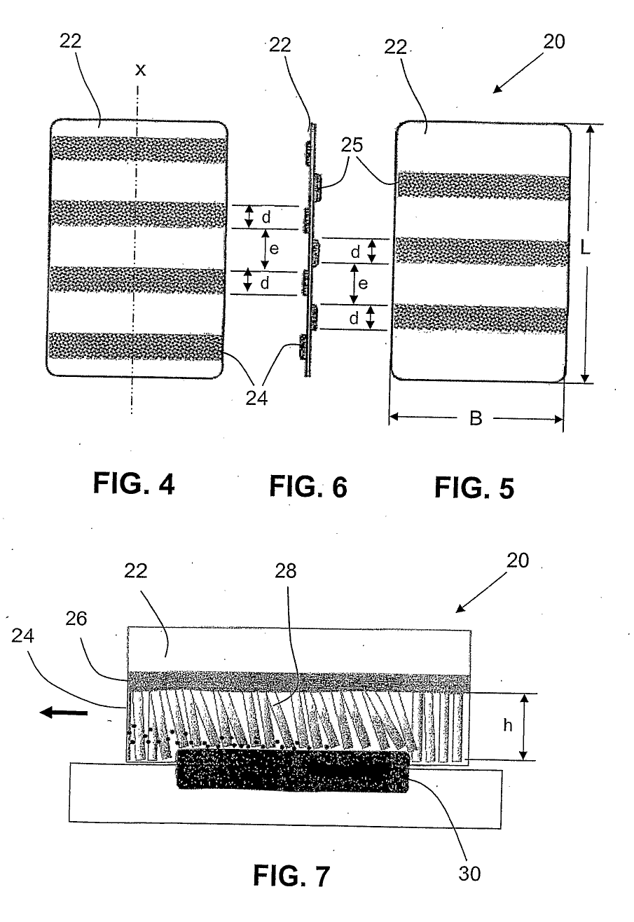

A cleaning card 20 for credit card machines which is illustrated in FIGS. 4 to 6 corresponds in its set-up essentially to the above-described cleaning strip 10 for cash machines and has a length L, corresponding to the dimensions of a credit card, of, for example, 85 mm and a width B of, for example, 54 mm. In the example shown, the longitudinal direction of the cleaning card 20 corresponds to the push-in direction x of the insertion reader of a credit card machine. The cleaning card 20 comprises a card or a strip 22 consisting of a carrier material composed, for example, of polyvinyl chloride (PVC) with a thickness of, for example, 0.3 mm. The strip 22 is provided on both sides with transverse strips 24, 25 consisting of a flock coating composed, for example, of polyamide (PA) with the flock dimensions 1.00 mm/3.3 dtex.

The transverse strips 24, 25 consisting of flock coating have, for example, a width d of 9 mm and a distance between adjacent transverse strips of 12 mm.

In the example shown, in each case four transverse strips 24 are arranged on the front side and in each case three transverse strips 25 are arranged on the rear side of the card or strip 22, the transverse strips 24 on the front side being arranged so as to be offset with respect to the transverse strips 25 on the rear side in the longitudinal direction of the strip 22 such that the transverse strips 24 on the front side lie in each case between the transverse strips 25 on the rear side, and vice versa. The height h of the transverse strips 24, 25 consisting of the flock coating corresponds approximately to the length of the individual flock fibers arising from the surface of the strip 22 consisting of carrier material, that is to say, in the present example, to about 1 mm.

FIG. 7 shows the arrangement of the flock fibers 28, fixed via an adhesive layer 26 on the strip 22 as carrier material, in a transverse strip 24 during the cleaning of a magnetic head 30 of the card reader of a credit card machine. Owing to the brush action of the flock coating, effective cleaning is obtained. The outstanding dirt uptake of the flock prevents the dirt from merely being distributed inside the card reader. The particles are taken up by the fibers and removed by the card being taken out.

To increase the cleaning action, the flock coating of the transverse strips 14, 15 and 24, 25 may be impregnated with a cleaning agent. In this case, the moist cleaning strips or cleaning cards 10, 20 are stored in a fluid-tight bag until they are used.

The parts to be cleaned by a cleaning strip 10 for cash machines relate, above all, to transport rollers and transport belts, sensors and reference surfaces, and the parts to be cleaned by a cleaning card 20 for credit card machines relate, above all, to transport rollers, sensors, magnetic heads and chips.

In the examples illustrated, the longitudinal direction of the cleaning strip or cleaning card always corresponds to the machine direction or the push-in direction, that is to say it corresponds to the longitudinal direction of the banknotes or credit cards which likewise usually have to be pushed in their longitudinal direction into the corresponding cash machine or credit card machine. In machines with banknotes or credit cards which have to be pushed in transversely to their longitudinal direction, the cleaning strips or cleaning cards are likewise pushed in transversely to their longitudinal direction, in any event the transverse strips on the cleaning strips and cleaning cards being arranged transversely to the machine direction or push-in direction.

The arrangement of the transverse strips consisting of flock on the cleaning strips and cleaning cards, the width of the transverse strips, the distance between the transverse strips, the length of the flock fibers and the flock density, the chemical composition of the flock, the set-up of the strips and cards and the composition of the carrier materials used are not restricted to the embodiments described above and illustrated by way of example in the drawing. In particular, the scope of protection also embraces cleaning strips and cleaning cards in which only one side is provided with transverse strips and the other side has a full-area or even no flock coating.

### LIST OF REFERENCE SYMBOLS

10 cleaning strip for cash machines
12 strip consisting of carrier material
14, 15 transverse strips consisting of flock coating
20 cleaning card for credit card machines
22 strip consisting of carrier material
24, 25 transverse strips consisting of flock coating
26 adhesive layer
28 flock fiber
30 magnetic head
L length of 10 or 20
width of 10 or 20
d width of 14, 15 or 24, 25
e distance 14-14, 15-15 or 24-24, 25-25
x machine direction
h height of the transverse strips or flock fibers

1. A cleaning strip or cleaning card for cash and credit card machines, with a strip coated with flock fibers and consisting of a carrier material, two mutually opposite strip edges defining a machine direction, and the width, measured transversely to a push-in direction into a cash and credit card machine, of the strip corresponding essentially to the length of a side edge of a banknote or credit card suitable for use in a cash and credit card machine to be cleaned, characterized in that the strip (12, 22) has on at least one of its surfaces at least three transverse strips arranged at a distance from one another transversely to the machine direction provided with a coating of flock fibers.

2. The cleaning strip or cleaning card according to claim 1, characterized in that the transverse strips are arranged on both surfaces of the strip.

3. The cleaning strip or cleaning card as claimed claim 1, characterized in that the transverse strips have a width of 5 to 15 mm, preferably of 8 to 12 mm.

4. The cleaning strip or cleaning card according to claim 1, characterized in that the transverse strips have a mutual distance of 5 to 20 mm, preferably of 8 to 18 mm.

5. The cleaning strip or cleaning card according to claim 2, characterized in that the transverse strips arranged on one side of the strip lie between the transverse strips arranged on the other side of the strip.
